(19) United States
(12) Patent Application Publication
(10) Pub. No.: US 2009/0119606 A1
(43) Pub. Date: May 7, 2009

(54) SYSTEM AND METHOD FOR COMBINING INSTANT MESSAGING WITH EMAIL IN ONE CLIENT INTERFACE

(76) Inventor: Bryan Gilbert, Victoria (CA)

Correspondence Address: HOFFMAN WARNICK LLC, 75 STATE ST, 14TH FLOOR, ALBANY, NY, 12207, US

(21) Appl. No.: 11/934,895

(22) Filed: Nov. 5, 2007

(51) Int. Cl. G06F 3/048

(52) U.S. Cl. 715/758

(57) ABSTRACT

A system and method for seamlessly merging chats and email into one user interface is provided. The system and method of the present invention does not require that all users have access to the technology. Users of the technology can continue to communicate with others who may use email or their instant messaging system, although some of the minor features require that all users have the same technology. Terms used to describe the invention are “ChatMail” and “ChatThread”. ChatMail suggests the blend of chat and email while ChatThread suggests a blend of chat and an email “thread” which is a common semi-technical term that means a series of emails that share a common subject.

### FIELD OF THE INVENTION

The present invention relates generally to email and instant messaging systems and, more specifically, to a system and method for combining instant messaging and electronic email into one application and, further, to a system and method where the user does not have to be aware which technology is being used to send the message.

### BACKGROUND OF THE INVENTION

In today's world, there are two commonly used communication tools; email and instant messaging (chats). E-mail (short for electronic mail; often also abbreviated as e-mail, email or simply mail) is a store and forward method of composing, sending, storing, and receiving messages over electronic communication systems. Email messaging requires an email client such as IBM's Lotus Notes® (see http://www-142.ibm.com/software/sw-lotus/products/product4.nsf/wdocs/noteshomepage), generally installed on a general purpose computer (see http://computer.howstuffworks.com/pc.htzxswe34m) which has a communications device that connects to an email server via network. Instant messaging (IM) is a form of real-time communication between two or more people based on typed text. The text is conveyed via computers connected over a network such as the Internet. Instant messaging requires an instant messaging client such as IBM's Lotus Sametime® client (see http://www-142.ibm.com/software/sw-lotus/products/product3.nsf/wdocs/st75home/), like the email client, generally installed on a general purpose computer having a communications device for connecting to the network.

Each communication tool runs in separate applications and each has advantages and drawbacks. Email has the following drawbacks:

1. Email lacks a way to display a related topic in one cohesive view. For example, in a chat window, the user can see the whole chat history at a glance. Yet, in the email client, the user can only see the last email received and it only contains a history if the sender included the history.
2. Each email received is shown as a separate unrelated entity in the email client. To manage all emails which are related, the user is required to manipulate each email individually.
3. The email system may be slow to replicate which causes frustration when a sender wishes to send a quick reply to someone the sender knows is “on-line”.
4. Email can cause redundancy as the sender needs to “include history” to help the recipient to understand the context of what was sent. The recipient ends up with email document after email document accumulating in both the sender's and recipient's inbox and sent items folders.
5. In order for a user to clean up his inbox and remove a “thread”, he needs to go into the inbox, sent items, and possibly other folders to find all of the emails of the thread.

Chat has the following drawbacks:

1. Chats have no topic. A chat does not have a subject (i.e., “Subject” line) and requires the communication between the two communicating parties to give the chat context.
2. Each individual chat generally requires a new window. Users can become overwhelmed with multiple chat windows competing with each other for attention. Some chat clients bring a chat window to the foreground and force the user interface (UI) focus into this window whenever new content arrives. Even if the content has no importance (for example, the sender is just saying “good bye”).
3. Chats either have no history or the history is unrelated to the topic. By “no history”, it is meant that chat systems that do not record and display previous chats with the participant. With newer chat clients (e.g., IBM's Lotus Sametime 7.5 chat client), the chat history is displayed and the user sees the last chat the user had with this person regardless of whether the present topic is related or not to the previous chat.
4. Chats can only be initiated if the target recipient is available (i.e., the target recipient is on the network and has activated his chat client).
5. Sometimes, the last bit of a conversation gets lost because the person the user is communicating with goes “off-line” in the midst of the chat.
6. Some clients may keep a history of the user's conversations but don't provide a way to organize them by topic.
7. IM clients create a lot of windows. It is hard to manage these windows and keyboard input is often put into the wrong window as the program brings the window with new content to the front.
8. Sometimes, a user wishes to communicate with someone only to find that someone is not “on-line” and the user has to use email.
9. Some IM clients offer to send an IM message as an email but the history of the previous conversation is lost so that the user needs to copy it into the email.
10. Some IM clients allow a user to invite new people into the chat but the new people cannot see the previous conversation.

There are some combined drawbacks in that chat and email are not related. Users must go back and forth to get features of each.

There is a need for a system and method for combining instant messaging and electronic email into one application. Further, there is a need for a system and method where the system chooses the best technology to convey the message and the user is not even be aware which technology is being used to send the message.

### BRIEF SUMMARY OF THE INVENTION

The present invention provides a system and method for seamlessly merging chats and email into one user interface. The system and method of the present invention does not require that all users have access to the technology. Users of the technology can continue to communicate with others who may use email or their instant messaging system, although some of the minor features require that all users have the same technology. Terms used to describe the invention are “ChatMail” and “ChatThread”. ChatMail suggests the blend of chat and email while ChatThread suggests the blend of chat and an email “thread” which is a common semi-technical term that means a series of emails that share a common subject.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts the email/chat system of the present invention.

FIG. 2 depicts a user interface of an embodiment of the present invention.

FIG. 3 depicts a user interface of an embodiment of the present invention.

The drawings are intended to depict only typical aspects of the invention, and therefore should not be considered as limiting the scope of the invention. In the drawings, like numbering represent like elements between the drawings.

### DETAILED DESCRIPTION OF THE PREFERRED EMBODIMENT OF THE PRESENT INVENTION

The present invention provides system and method for allowing users to communicate via email and chat sessions in a seamless exchange. The system and method of the present invention no longer requires separate chat windows, the users no longer need to manage chat history, the users no longer have 100 s of separate email messages but instead have list of active chats and inactive chats.

The system and method of the present invention is able to run as a different view in the user's favorite email client and seamlessly blends both email or chat technology although the recipient can continue to use his traditional email or chat client. New content arrives (e.g., normally chat window is automatically brought to the foreground and given focus) but doesn't disrupt the user. Instead, the application title bar can change icon to flag new content—unless it is already the focus.

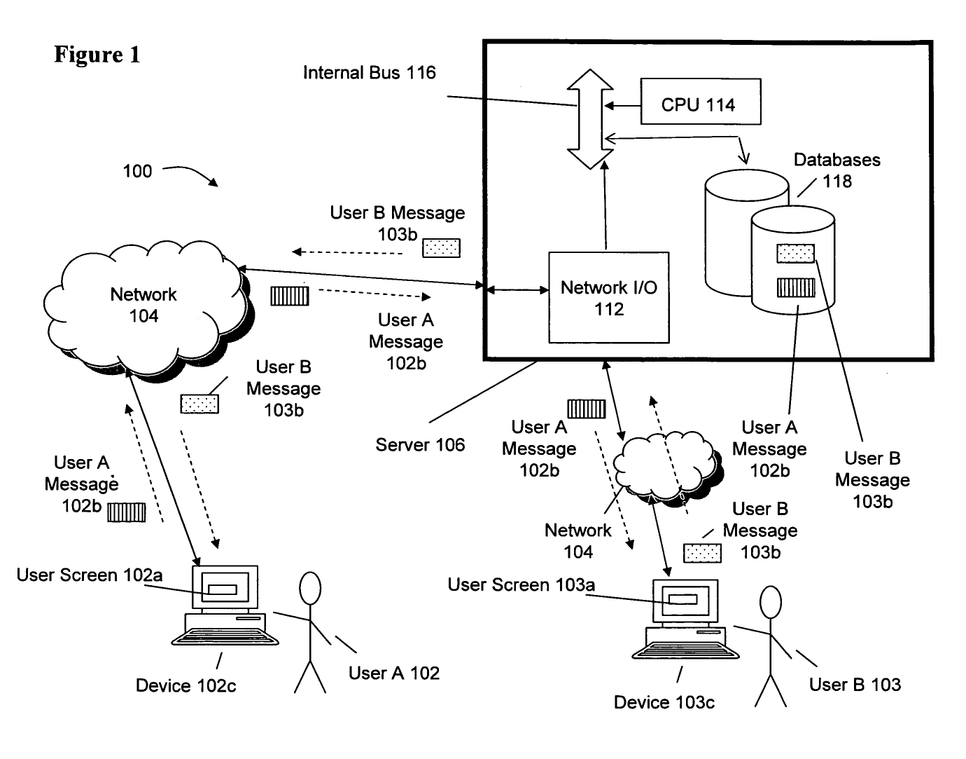

FIG. 1 illustrates the email/chat system 100 of the present invention. User A 102 wishes to communicate with User B 103. Instead of phoning, User A 102 (“Originator”) uses email and sends an original email or an instant message (“IM”) (“User A Message 102b”) to communicate with User B 103 or other users (“Recipients”). The email/chat system 100 allows User A's and User B's screens 102a, 103a to illustrate the email/chat thread (or string of emails/chat) between User A 102 and User B 103 (and other users possibly). Email messaging requires an email client such as IBM's Lotus Notes® (see http://www-142.ibm.com/software/sw-lotus/products/product4.nsf/wdocs/noteshomepage), generally installed on a general purpose computer (see http://computer.howstuffworks.com/pc.htzxswe34m) which has a communications device that connects to an email server 106 via network 104. (However, the Devices 102c, 103c don't need to be personal computers as they can as easily be cell phones, PDAs and the like.) Likewise, instant messaging requires that the user have an IM client such as IBM Lotus Sametime® client installed locally. More information can be found here: http://www-142.ibm.com/software/sw-lotus/products/product3.nsf/wdocs/st75home.) Like most, if not all, servers, Server 106 has a network input/output device 112 to receive and send messages, one or more CPUs 114, databases 118 to store email thread and IM messages and other data related to conversation sessions, and an internal bus 116 like other computers. User A Message 102b is stored in Databases 118 and is forwarded to User B 103 to be displayed on Device 103c on User B's Screen 103a.

Mixed formats are separated by thin line. The system handles each type of content separately.

The invention has two components;

1. a user interface (UI) along with all the workflow and process; and
2. a back-end process and algorithms that process the email and chat technology to present the merged view. Note that this is described as mainly a client technology although other implementations could utilize improvements on the server-side to facilitate correspondents who have access to this technology. The UI is hosted in an email client. This client is chosen rather than the chat client because this invention allows for all the features of the chat client yet cannot replace all the features of email. For an example of the latter, consider that this invention does not handle the “broadcast” email. The following discussion about how the UI works is not meant to be limiting the invention but to illustrate one way it can be implemented.

Typical email clients present a two panel display. On the left is a “tree view” or directory listing. Usually this view shows the “In Box”, “Contacts”, and “Folders”. This invention adds two new top level items “Active ChatThreads” and “Inactive ChatThreads”. Under these ChatThread headings, the user sees a list of previous ChatMails. The list shows the ChatMail's subject and can be ordered in various ways (alphabetically by subject, alphabetically by correspondents, or chronologically by last update, etc.)

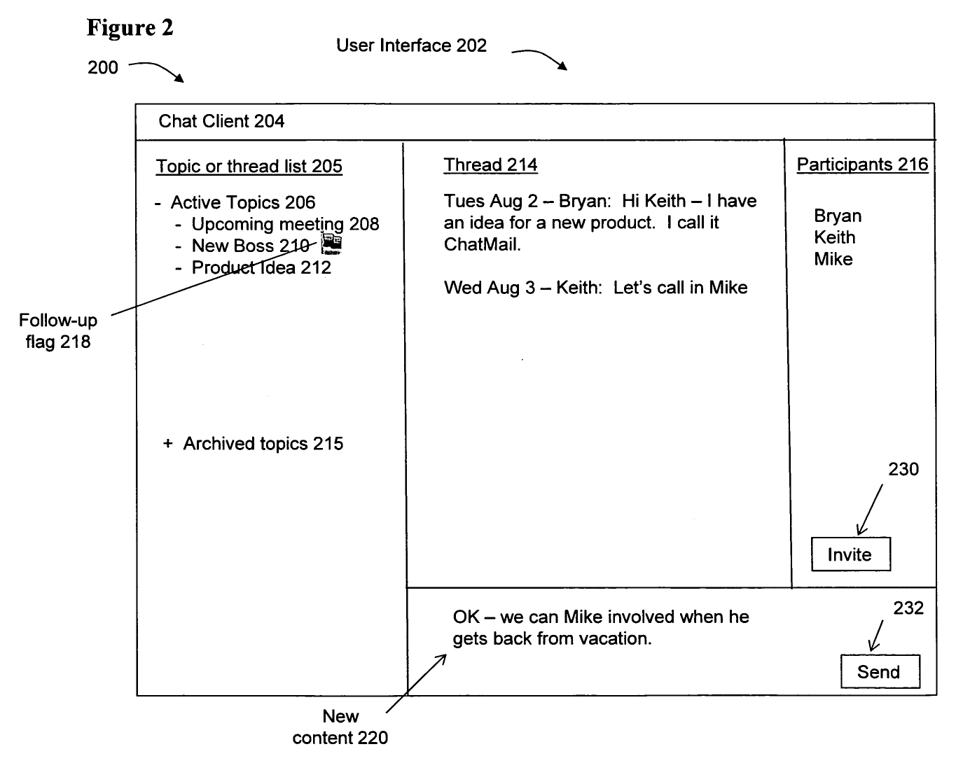

A thread window is generally portrayed like chat window 200 (e.g., using a chat/IM client such as the IBM Lotus SameTime) and can display RTF, HTML and plain text (if mixed due to the way other users send their content) as shown in FIG. 2. User interface 202 shows a chat client interface 204 where, along the left side is a topic or thread list 205 having lists of active topics 206 and archived topics 215. Some topics may have a follow-up flag 218 to indicate to the user to follow up with the recipient on that issue.

The thread window 214 is shown in the middle of the window. New content 220 is entered in a separate frame while the active participants 216 are indicated along the right hand side. The “Send” button 232 is depressed when the user has completed his/her IM. Of course, the layout may be changed according the user's preferences.

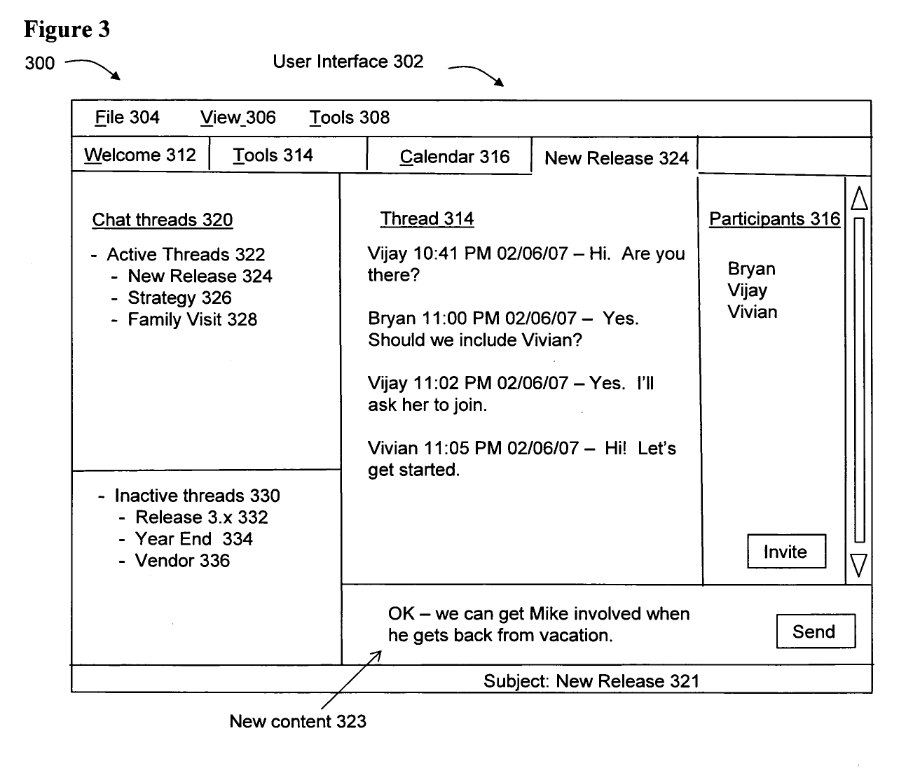

FIG. 3 300 illustrates the user interface 302 of the present invention having a merged email/IM UI. For example, chat threads 320 are shown along the upper left hand side while the inactive threads 330 are shown along the lower left hand side. In addition, other tools (typically available only in the email client), such as Welcome 312, Tools, 314, Calendar 316, etc. This is in contrast to previous chat windows which do not allow the merging of chat and email windows. Tabbed windows, such as the active window New Release 324, display different content. New Release 324 displays the instant messaging between the IM participants. Subject line 321 indicates the subject of the chatter which, in this case, is New Release. New Release 324 is also shown under Active Threads 322.

ChatMail Management

The Active ChatThread list shows ChatMail that has been active within a certain (configurable) period of time, such the last few business days. The Inactive ChatThread list contains ChatMail that has not been active and has been placed there automatically by the system. If new content is sent or received on one of these ChatMail items then it is moved to the Active section automatically. Users can move active ChatMail items into this Inactive list manually and vice versa. Also, users can organize inactive ChatMails into folders for archiving purposes, much like they do now with email. When a user selects a ChatMail item in one of the ChatThread lists the right hand pane presents three main parts. The top right sub-panel is the largest one and shows a view similar to what users see in chat technology. It shows the back and forth dialog between the participants. This panel is named the “ChatThread” panel. Each entry is listed with the participant's name and time of transmission. Unlike chat clients, the content can contain elements seen in RTF and HTML based email clients. HTML content with embedded URLS that require access to the network can be blocked from accessing the network unless the user deems the message is safe and comes from a trusted source.

The top right sub-panel is tall and narrow. It lists the participants and may show their current online status or other relevant information. This panel has a button that lets the user “invite others”. This panel is called the “Recipients” panel.

The bottom panel 323 spans the two top panels 314, 316 and contains the area the user can enter new content. Unlike chat clients, this area would behave like an email editor. Thus, users can enter text in plain, RTF or HTML formats and they can attach documents or embed images. (The Rich Text Format (often abbreviated to RTF) is a proprietary document file format developed by Microsoft in 1987 for cross-platform document interchange. Most word processors are able to read and write RTF documents. HTML, a contraction of Hypertext Markup Language, is the predominant markup language for web pages. It provides a means to describe the structure of text-based information in a document—by denoting certain text as headings, paragraphs, lists, and so on—and to supplement that text with interactive forms, embedded images, and other objects.) The bottom panel has a “Send” button which, when depressed by the user, transmits the message. This panel is called the “Message” panel.

Other common email and chat user features would be presented as well. The above is just the essence of the interface. Common UI features like scroll bars and resizable/fullscreen windows are supported. The present invention provides a means to initiate a new ChatMail. When the user is about to send the first email, they do not need to decide if they wish to use the underlying email or chat technology as the system does that automatically. The system determines if the recipient is available and, if so, utilizes chat instead of email if it is not a long conversation (see below). If the recipient is not available or it is a long conversation, the system utilizes email instead of chat as the mechanism to convey the message. In general, once a ChatMail starts as a chat, it continues to use chat technology. Likewise, for email, once it starts as an email it remains an email. It is conceivable that a ChatMail item could switch back and forth as needed, either by the system because one or more recipients is not available or because the users wishes to send a short Chatmail “aside” message during a longer discussion.

The system focuses on answering the question “is this a conversation?” or “is this a longer discussion?” The system defaults to chat for a conversation (if the recipient is available) and email for a longer conversation (or if the recipient is unavailable). New incoming messages from either technology are treated the same and appear under the Active ChatThreads list. (Exceptions might be broadcast emails (e.g., recipients are groups rather than individuals) in which case the email would remain in the InBox.)

Incoming updates to existing ChatMails initiate a notification to the user. These alerts are already common in email and chat clients. The “Contacts” list of the email client add in the features commonly seen in chat client, such as showing if the user is on-line and providing automatic groups of users with directory lookup (such as IBM's Bluepages® directory look up functionality). The user can multi-select other users and choose to initiate a ChatMail with them.

Back-End Chat Processing.

The back-end is also hosted in the email client. The client needs to send and receive instant messages on behalf of the user. Like standard chat clients, the ChatMail client stores the chat messages and may choose to do so by saving them as email entities. By using email entities, the client can make use of the Server to store the data. The client needs to process incoming email and remove the “history”. For plain text, it can do this with standard “differencing technology” by comparing the last sent email with the incoming email. The difference is displayed in the ChatThread panel. For other formats (RTF) and (HTML) a tool like “Diff Doc” (see http://www.softinterface.com/MD/Document-Comparison-Software.htm) could be embedded into the client to provide the new content.

The client consolidates series of emails and present them in the single ChatThread view.

In order to match incoming messages with existing threads, the system and method of the present invention utilizes the concept of globally unique identifiers. That is, each ChatMail thread has a globally unique identifier so that the messages and existing threads are matched appropriately. Each message is also given a globally unique identifier. A global unique identifier or GUID is a special type of identifier used in software applications in order to provide a reference number which is unique in the context for which it is used, for example, in defining the internal reference for a type of access point in a software application, or for creating unique keys in a database. The globally unique identifiers are also used to handle error conditions such as, for instance, the message is received twice via email and IM.

In another embodiment of the present invention, the message may be sent via both email and IM. Since the message has a globally unique identifier, the receiving ChatMail client can discard any duplicates. This method can only be used if all participants are using ChatMail enabled clients and, as such, the system would need to allow for the ChatMail clients to have a way of registering themselves, with the servers, as ChatMail enabled.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A method for allowing users to communicate via email and chat sessions in a seamless exchange without separate chat windows and further allowing users to no longer need to manage chat history, the users having email clients to communicate with one another, the method comprising the steps of:
displaying, as a different view in the user's email client, one or more conversations;
seamlessly blending both email or chat technology in the user interface of the user's email client;
receiving new chat or email content without disrupting the receiving user; and
changing an icon to flag new content unless the new content is already the focus.

2. The method of claim 1 further comprising the step of separating, on the user's user interface, mixed formats of content.

3. The method of claim 1 further comprising the step of displaying, on the user's user interface, chat threads which are active, and chat threads which are inactive.

4. The method of claim 3 further comprising the step of allowing the user to order the chat threads in various ways such as alphabetically by subject, alphabetically by correspondents, or chronologically by last update.

5. The method of claim 4 further comprising the step of allowing the user to utilize typical email tools.

6. The method of claim 1 further comprising the step of displaying a subject line for the chat.

7. The method of claim 3 further comprising the steps of moving an active chat thread to the inactive chat thread portion of the user's user interface after a predetermined period of time and allowing the user to select the predetermined period of time.

8. The method of claim 7 further comprising the steps of moving an inactive chat thread to the active chat thread portion of the user's user interface if new content is sent or received on one of these inactive chat threads.

9. The method of claim 1 further comprising the steps of defaulting to chat for a conversation and defaulting to email for a longer conversation.

10. A computer program product in a computer readable medium for operating in a system comprising a network I/O, a CPU, and one or more databases, for implementing a method for combining instant messaging and electronic email into one application, the method comprising the steps of displaying, as a different view in the user's email client, one or more conversations; seamlessly blending both email or chat technology in the user interface of the user's email client; receiving new chat or email content without disrupting the receiving user; and changing an icon to flag new content unless the new content is already the focus.

11. The computer program product of claim 10 wherein the method further comprises the step of separating, on the user's user interface, mixed formats of content.

12. The computer program product of claim 11 wherein the method further comprises the step of displaying, on the user's user interface, chat threads which are active, and chat threads which are inactive.

13. The computer program product of claim 12 wherein the method further comprises the step of allowing the user to order the chat threads in various ways such as alphabetically by subject, alphabetically by correspondents, or chronologically by last update.

14. The computer program product of claim 13 wherein the method further comprises the step of allowing the user to utilize typical email tools.

15. The computer program product of claim 10 wherein the method further comprises the step of displaying a subject line for the chat.

16. The computer program product of claim 12 wherein the method further comprises the steps of moving an active chat thread to the inactive chat thread portion of the user's user interface after a predetermined period of time and allowing the user to select the predetermined period of time.

17. The computer program product of claim 16 wherein the method further comprises the steps of moving an inactive chat thread to the active chat thread portion of the user's user interface if new content is sent or received on one of these inactive chat threads.

18. The computer program product of claim 10 wherein the method further comprises the steps of defaulting to chat for a conversation and defaulting to email for a longer conversation.
